(19) United States
(12) Patent Application Publication
(10) Pub. No.: US 2012/0233451 A1
(43) Pub. Date: Sep. 13, 2012

(54) METHOD FOR FAST RESUMING COMPUTER SYSTEM AND COMPUTER SYSTEM

(75) Inventors: Chih-Chien Liu, Taipei City (TW); Yi-Chang Chen, Taipei City (TW); Shao-Tsu Kung, Taipei City (TW); Chih-Hsing Kang, Taipei City (TW); Chun-Sheng Chen, Taipei City (TW); Chih-Jung Lai, Taipei City (TW)

(73) Assignee: COMPAL ELECTRONICS, INC., Taipei City (TW)

(21) Appl. No.: 13/414,740

(22) Filed: Mar. 8, 2012

Related U.S. Application Data
(60) Provisional application No. 61/450,601, filed on Mar. 8, 2011.

(51) Int. Cl. G06F 9/00; G06F 1/24; G06F 1/26

(52) U.S. Cl. 713/2

(57) ABSTRACT

A method for fast resuming a computer system from a shutdown state is provided. The computer system comprises a basic input output system (BIOS), a system memory and a storage device storing a system memory data of the system memory and a used system memory block address table before the computer system enters the shutdown state. The method comprises receiving a starting signal for power supplying the computer system and starting the storage device. A fast boot built-in program of the BIOS is started and, according to the used system memory block address table, the fast boot built-in program sequentially reads the stored system memory data from the storage device and writes the read system memory data into the system memory with a use of an optimized read-and-write block size as a read-and-write unit. The computer system enters a suspended state and is resumed from the suspended state.

### CROSS-REFERENCE TO RELATED APPLICATION

This application claims the priority benefits of U.S. provisional application Ser. No. 61/450,601, filed on Mar. 8, 2011. The entirety of the above-mentioned patent application is hereby incorporated by reference herein and made a part of this specification.

### BACKGROUND OF THE INVENTION

1. Field of Invention

The present invention relates to an operating method and a computer system. More particularly, the present invention relates to a method for fast resuming a computer system and a computer system.

2. Description of Related Art

In the standards of the advanced configuration and power interface (ACPI), the modes of the computer system, except for the working mode (i.e. S0 mode), further comprises the sleeping mode in which the computer consume less power. According to different power consuming amounts and different resuming speeds, the sleeping mode can be classified into several states including S1 state, S3 state, S4 state and S5 state. Under the S1 state (i.e. power-on-suspend state), the computer system only turns off the display so that the it can resume back to the working mode rapidly. Under the S3 mode which is so-called suspend-to-ram state, except for supplying power to the memory and the controller of the memory for maintaining the data, the power for all other devices is cut off. In the S4 state (i.e. suspend-to-disk state), the data in the memory are stored into the hard disc so that it is not necessary to supply power to the memory. Further, the so-called S5 state is the shutdown state in which only few suspended power is maintained for the computer system.

It is obvious that the further the power-saving mode is, the longer time required to resume the working state. Further, among the aforementioned states of the sleeping mode, the S5 state is the most power saving state. However, when the computer system is resumed from the S5 state, the power-on-self test (POST) is performed by the basic input output system (BIOS) so as to initialize and scan the peripheral hardware device of the computer system and to write related setting values to the peripheral hardware devices until corresponding drivers are loaded. The aforementioned operations lead to a very long booting time of the computer system.

Moreover, when the computer system enters the S3 state, it is necessary to supply power to the memory to maintain the memory content. Otherwise, once the power supplying to the memory is cut off, the memory content is lost and the computer system cannot be resumed to the operating state before it enters the S3 state. Hence, when the computer system is in the S3 state for a long time, the battery needs to continuously supply power to the memory. Therefore, the life-time of the battery is decreased easily.

### SUMMARY OF THE INVENTION

The present invention provides a method for resuming a computer system capable of fast resuming the computer system.

The present invention provides a computer system capable of extending the suspended time and prolonging the battery lifetime.

As embodied and broadly described herein, the invention provides a method for fast resuming a computer system from a shutdown state. The computer system comprises a basic input output system (BIOS), a system memory and a storage device storing a system memory data of the system memory before the computer system enters the shutdown state and a used system memory block address table. The method comprises receiving a starting signal for power supplying the computer system and starting the storage device. A fast boot built-in program of the basic input output system is started and, according to the used system memory block address table, the fast boot built-in program sequentially reads the stored system memory data from the storage device and writes the read system memory data into the system memory with a use of an optimized read-and-write block size as a read-and-write unit. The computer system enters a suspended state and the computer system is resumed from the suspended state.

According to one embodiment of the present invention, the computer system comprises a central processing unit and a chipset, and the computer system entering the shutdown state further comprises cutting off the power supplying to the central processing unit, starting the fast boot built-in program, according to the used system memory block address table, to sequentially store the system memory data of the system memory into the storage device with the use of the optimized read-and-write block size as the read-and-write unit and the basic input output system setting the chipset to enable the computer system to enter the shutdown state. Additionally, before the step of cutting off the power supplying to the central processing unit, the method of the present invention further comprises receiving a shutdown signal and according to the shutdown signal, starting a control program to inform an operating system currently run by the computer system to perform a logout operation. Also, before the step of cutting off the power supplying to the central processing unit and after the step of performing the logout operation, the method of the present invention further comprises the operating system currently run by the computer system generating a suspension command, the basic input output system trapping and interrupting the suspension command, the basic input output system starting the fast boot built-in program to store a set of setting value of the chipset into the system memory and the fast boot built-in program scanning the system memory to build the used system memory block address table of the system memory.

According to one embodiment of the present invention, before the step of cutting off the power supplying to the central processing unit, the present invention further comprises setting a real-time clock for determining a temporal suspended time interval, wherein the step of cutting off the power supplying to the central processing unit further comprises the computer system entering the suspended state so as to cut off the power of the central processing unit and after the computer system maintains in the suspended state for the temporal suspended time interval, power supplying the central processing unit and resetting the central processing unit. Also, the step of power supplying the central processing unit after the temporal suspended time interval comprises the step of an embedded controller (EC) or a hardware circuit power supplying the central processing unit.

According to one embodiment of the present invention, before the computer system enters the shutdown state, an operating system run by the computer system is at a first operating state and when the computer system is resumed from the suspended state, the operating system run by the computer system is at a second operating state as same as the first operating state.

According to one embodiment of the present invention, after the step of power supplying the computer system, the method of the present invention further comprises the fast boot built-in program clearing the system memory. Also, before the step of the fast boot built-in program clearing the system memory, the method of the present invention further comprises initializing the system memory and after the step of the fast boot built-in program clearing the system memory, further comprising initializing the storage device.

According to one embodiment of the present invention, the step of fast boot built-in program, according to the used system memory block address table, sequentially reading the stored system memory data from the storage device further comprises the fast boot built-in program automatically detecting the optimized read-and-write block size of the storage device.

According to one embodiment of the present invention, the step of fast boot built-in program, according to the used system memory block address table, sequentially reading the stored system memory data from the storage device further comprises the fast boot built-in program automatically reading a set value of a read-and-write block size of the storage device and using the read set value as the optimized read-and-write block size. Further, the set value of read-and-write block size of the storage device is a set value of an original data read-and-write block size of the storage device or a read-and-write block size which is used to write the system memory data into the storage device before the computer system shutdown.

The present invention further provides a computer system. The computer system comprises a central processing unit, a chipset, a system memory, a storage device and a basic input output system. The central processing unit is used for executing an operating system. When the computer system is in a shutdown state, the storage device stores a system memory data of the system memory and a used system memory block address table before the computer system enters the shutdown state. When the computer system is in a shutdown state and is resumed from the shutdown state, the basic input output system starting a fast boot built-in program of the basic input output system, according to the used system memory block address table, to sequentially read the stored system memory data from the storage device and write the read system memory data into the system memory with a use of an optimized read-and-write block size as a read-and-write unit; making the computer system to enter a suspended state; and resuming the computer system from the suspended state.

According to one embodiment of the present invention, when the computer system in the shutdown state and a power of the central processing unit is cut off, the basic input and output system: starting the fast boot built-in program, according to the used system memory block address table, to sequentially store the system memory data of the system memory into the storage device with the use of the optimized read-and-write block size as the read-and-write unit and setting the chipset to enable the computer system to enter the shutdown state. Also, before the power of the central processing unit is cut off, the operating system generates a suspension command and the basic input and output system trapping and interrupting the suspension command and starting the fast boot built-in program to store a set of setting value of the chipset into the system memory and scanning the system memory to build the used system memory block address table of the system memory.

According to one embodiment of the present invention, the computer system further comprises a real-time clock, wherein the basic input output system sets the real-time clock for determining a temporal suspended time interval, enables the computer system maintaining in the suspended state for the temporal suspended time interval in which the power of the central processing unit is cut off and power supplies and rests the central processing unit after the temporal suspended time interval. Also, the computer system comprises a controller for power supplying and resetting the central processing unit.

According to one embodiment of the present invention, before the power of the central processing unit is cut off, the central processing unit receiving a shutdown signal and according to the shutdown signal, starting a control program to inform the operating system currently run by the computer system to perform a logout operation.

According to one embodiment of the present invention, before the computer system is in the shutdown state, the operating system run by the computer system is at a first operating state and when the computer system is resumed from the suspended state, the operating system run by the computer system is at a second operating state as same as the first operating state.

According to one embodiment of the present invention, when the computer system is resumed from the shutdown state, before the used system memory block address table is read from the storage device, the basic input output system initializing the system memory, clearing a memory content of the system memory and initializing the storage device.

In the present invention, the computer system runs the operating system to executes the S3 state, the system memory data of the system memory is sequentially stored into the storage device and then the computer system enters the S5 state. Therefore, after the computer receives the resuming signal, the BIOS sequentially restores the system memory data stored in the storage device into the system memory and the operating system is awoke from the S3 state. That is, the operating state of the awoke operating system is as same as the operating state of the operating system before the computer system enters the shutdown state. Hence, the combination of the hybrid suspending process and the method for fast resuming the computer system omits the redundant steps of scanning the peripheral hardware device of the computer system and writing related setting values to the peripheral hardware devices in the booting procedure from the S5 state and further omits the steps of initiating the system background programs as the booting procedure is completed and the operating system starts. Thus, it is not necessary for the user to spend a lot of time to wait the computer system goes through the redundant booting steps and the environment preparation steps of the operating system. Therefore, the goal for fast resuming or booting the computer system can be achieved. Furthermore, in response to the power suspended signal generated by the user, the operating system enters the S3 state and then enters the S5 state so that the power required by the computer system is downed to the lower limit so that the lifetime of the battery can be prevented from being shortened due to the continuously supplying power to the system memory as the computer system is at the suspended state. Additionally, when the computer system is resumed to be in the operating state as same as the operating state of the operating system before the computer system enters the S5 state, so that the user would think the computer system is resumed from the S3 state. Thus, the user perception of the use of present invention includes the advantages such as long suspended time.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a computer system according to one embodiment of the present invention.

FIG. 2 is a flow chart showing a method for fast resuming a computer system according to one embodiment of the present invention.

FIG. 2A is a flow chart showing an initialization procedure of the system memory and the storage device in the method for fast resuming a computer system according to one embodiment of the present invention.

FIG. 3 is a flow chart showing a procedure of a computer system entering a shutdown state in the method for fast resuming a computer system according to one embodiment of the present invention.

FIG. 3A is a flow chart showing a procedure of a computer system entering the suspended state and being awoke from the suspended state before the computer system enters a shutdown state in the method for fast resuming a computer system according to one embodiment of the present invention.

FIG. 4A is a flow chart showing a procedure of a computer system entering the shutdown state according to the power button, the hot key or the shutdown software in the method for fast resuming a computer system according to one embodiment of the present invention.

FIG. 4B is a flow chart showing a method for fast resuming a computer system after the computer system is shutdown by performing a hybrid suspending process according to one embodiment of the present invention.

### DESCRIPTION OF THE PREFERRED EMBODIMENTS

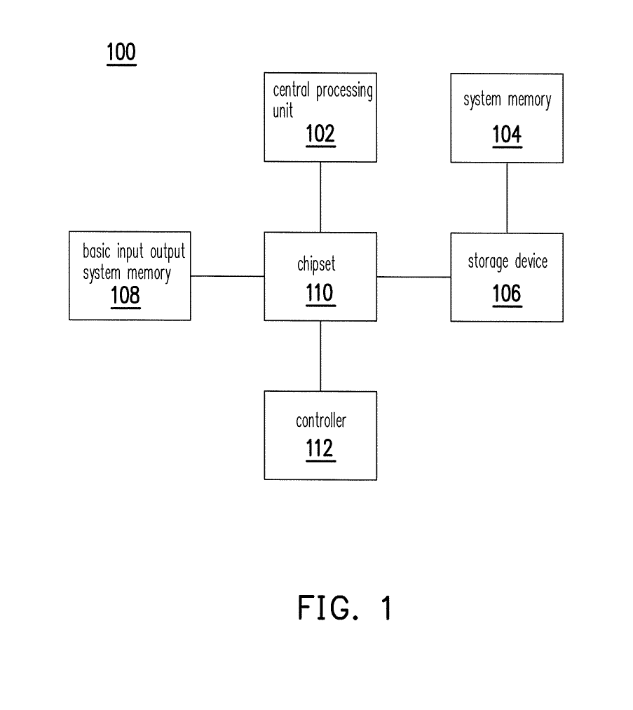

FIG. 1 is a schematic diagram showing a computer system according to one embodiment of the present invention. As shown in FIG. 1, in the present embodiment, a computer system 100 comprises a central processing unit 102, a system memory 104, a storage device 106, a basic-input-output system memory 108 and a chipset 110. The central processing unit 102 executes an operating system. The storage device 106 can be, for example, a storage unit of a hard disk driver (HDD), a solid state drive (SSD), a flash memory or a non-volatile memory. The system memory can be, for example, a random access memory (RAM). Furthermore, the basic-input-output system memory 106 is used to store a basic input output system (BIOS).

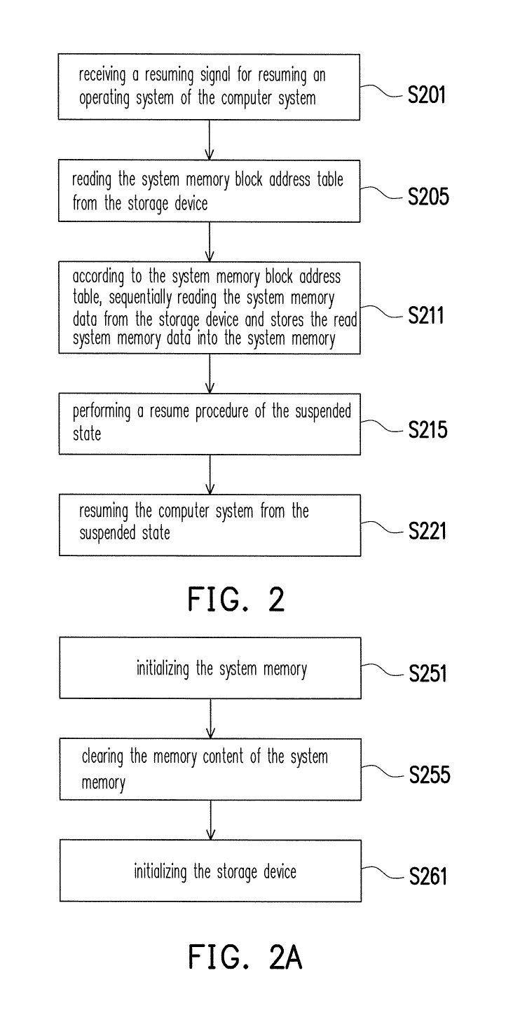

FIG. 2 is a flow chart showing a method for fast resuming a computer system according to one embodiment of the present invention. As shown in FIG. 1 and FIG. 2, in the present embodiment, the computer system 100 is in a shutdown state which is the S5 state under the definition of the ACPI standard. Moreover, the storage device 106 stores a system memory data (i.e. the used memory content) of the system memory 106 and a system memory block address table (i.e. the a used memory address table or a used system memory block address table) before the computer system enters the S5 state. That is, when the computer 100 is in the S5 state, the storage device 106 already stores the system memory data and the used system memory block address. Thus, the usage condition of the system memory 104 before the computer system 100 enters the S5 state is clearly recorded in the storage device 106 in the form of the system memory data and the system memory block address table. On the other words, the usage condition of the system memory 104 before the computer system 100 enters the S5 state is well reserved in the storage device 106 even the computer system 100 is already in the S5 state. It should be noticed that the system memory block address table records the address of each system memory datum while the system memory data are stored in the system memory. In the step S201, the computer system 100 receives a resuming signal for resuming an operating system of the computer system. For instance, the user generates a resuming signal through an input device (not shown) or a power button (not shown) of the computer system 100 in order to awake the operating system. According to the resuming signal, a controller of the computer system 100 (such as the controller 112 shown in FIG. 1 which can be an embedded controller (EC)) or a hardware circuit of the computer system 100 supplies power to the memory system.

In the step S205, the BIOS reads the system memory block address table from the storage device 106. Then, in the step S211, according to the system memory block address table, the BIOS sequentially reads the system memory data from the storage device 106 and stores the read system memory data into the system memory 104. According to the system memory block address table, the BIOS sequentially reads and writes the system memory data into the system memory 104, for example, in a block-by-block way with using a memory block as a read-and-write unit. For instance, the BIOS utilizes an optimized read-and-write block size as the read-and-write unit to read system memory data from the storage device 106 and write the read system memory data into the system memory 104. In another embodiment, the BIOS reads a set value of a read-and-write block size of the storage device 106 from the storage device 106 in advance and utilizes the read set value as the optimized read-and-write block size and as the read-and-write unit to read the system memory data and to write the read system memory data into the system memory 104. Moreover, the aforementioned set value of read-and-write block size of the storage device can be a set value of an original data read-and-write block size of the storage device or a read-and-write block size which is used to write the system memory data into the storage device before the computer system shutdown. In the other embodiment, the optimized read-and-write block size is determined according to the size of the data to be accessed. That is, the optimized read-and-write block size is determined in order to achieve the goals including least data reading times and largest data accessing rate. In the other embodiment, the optimized read-and-write block size is determined according to the storage capacity of the storage device. On the other words, the optimized read-and-write block size is determined in order to achieve the goals including least data reading times and largest data accessing rate.

In the conventional block-by-block data read-and-write operation, no matter how large the size of the data to be read is or how large the storage capacity of the storage device is, the fixed block size, such as 4 KB, 8 KB or 16 KB, is used as the read-and-write unit for reading and writing data. However, in the present invention, BIOS determines the optimized read-and-write block size, for example, before operations for reading and writing the system memory data are performed and utilizes the optimized read-and-write block size as the read-and-write unit. In addition, the optimized read-and-write block size is determined according to the size of the data to be accessed or the storage capacity of the storage device or the set value of read-and-write block size of the storage device is regarded as the optimized read-and-write block size. Thus, different sizes of the data to be accessed, different storage capacities of the storage device or different set values of read-and-write block size of the storage device lead to different read-and-write units respectively. In the present invention, since the read-and-write unit changes with the size of the data to be accessed, the storage capacity of the storage device or the set value of read-and-write block size of the storage device, the operation for reading and writing the system memory data possesses faster operating speed in comparison with the conventional block-by-block data read-and-write operation with the use of the fixed block size as the read-and-write unit. On the other words, the whole speed for awaking the computer system is increased.

Moreover, in the step S215, the BIOS performs a resume procedure of the suspended state. In the step S221, the operating system run by the central processing unit 102 of the computer system is resumed from the suspended state. It should be noticed that the suspended state is the S3 state in the definition of the ACPI standard. Noticeably, before the computer system 100 enters the shutdown state, the operating system run by the central processing unit 102 of the computer system 100 is at a first operating state and when the operating system is resumed from the suspended state (i.e. S3 state), the operating system run by the central processing unit 102 of the computer system 100 is at a second operating state which is as same as the first operating state.

That is, in the user's point of view, the operating system run by the computer system 100 is resumed to an operating state as same as the operating state of the operating system before the computer system shutdowns. Since, in the procedure that the computer system 100 is resumed from the S5 state, the BIOS sequentially restores the system memory data from the storage device 106 into the system memory 104 according to the system memory block address table so as to resume the system memory back to a state before the computer system enters the S5 state and then to execute the resume procedure of the S3 state (which is to resume the computer system from the S3 state), the conventional redundant booting procedure from the S5 state including the BIOS scanning the peripheral hardware device of the computer system and writing related setting values to the peripheral hardware devices can be eliminated and the time for initiating the system background programs (such as anti-virus programs or Internet signal auto-detecting program) as the booting procedure is completed and the operating system starts can be saved as well.

FIG. 2A is a flow chart showing an initialization procedure of the system memory and the storage device in the method for fast resuming a computer system according to one embodiment of the present invention. As shown in FIG. 2A, in one embodiment, after the step S201 of receiving the resuming signal and before the step S 205 of reading the system memory block address table from the storage device, the method of the present invention further comprises the step of initializing the system memory 104 by the BIOS (step S251), clearing the system memory (i.e. clearing the memory content of the system memory 104) (step S255) and initializing the storage device 106 (step S261).

Moreover, in another embodiment, after the step S211 of sequentially storing the system memory data read from the storage device 106 into the system memory 104 according to the system memory block address table and before the step S215 of performing the resume procedure of the suspended state, the method of the present invention further comprises steps of sending a reset command to the central processing unit 102 by the chipset 110 to reset the central processing unit 102. Moreover, in the other embodiment, after the step S215 of performing the resume procedure of the suspended state and before the step S221 of resuming the computer system from the suspended state, the method of the present invention further comprises steps of restoring the data of the registers of the chipset 110 to the chipset 110 from the system memory 106 and BIOS jumping to the wake-up vector of the S3 state to return the control of the process back to the operating system. Thus, in the step S221, the operating system executes the suspension resume and the computer system 100 is resumed from the suspended state.

In the present invention, since the storage device 106 of the computer system 100 stores the system memory data before the computer system 100 enters the shutdown state, the BIOS sequentially restores the system memory data into the system memory 104 from the storage device 106 in advance while the computer system 100 is resumed. Thus, the BIOS can execute the resume procedure of the suspended state so as to resume the operating system of the computer system from the suspended state in order to achieve the goal for fast resuming the operating system. The concept of the present invention in which the storage device 106 of the computer system 100 stores system memory data of the system memory 104 before the computer system enters the shutdown state (i.e. the S5 state) can be applied to the method for extending the suspended time of the computer system, lengthening the lifetime of the battery and fast booting the computer system. Several embodiments are described hereafter in order to explain the aforementioned applications.

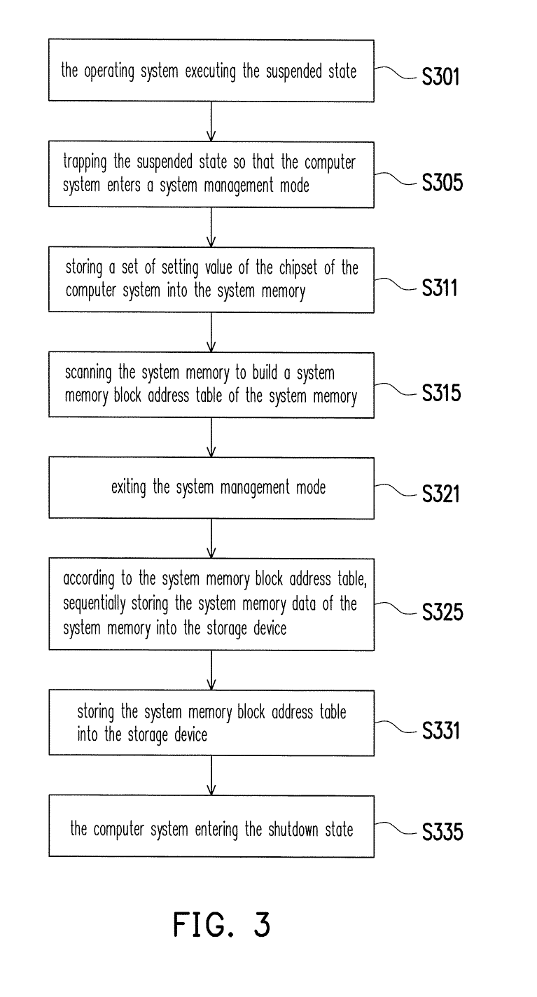

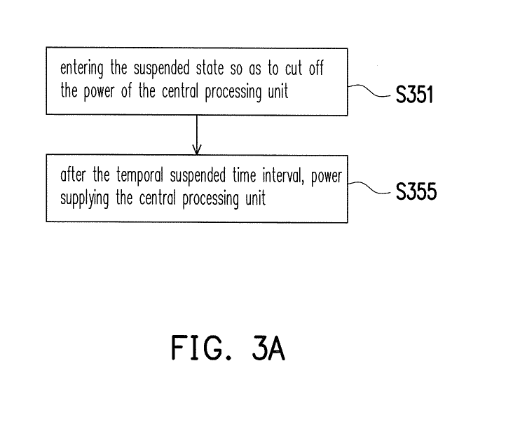

FIG. 3 is a flow chart showing a procedure of a computer system entering a shutdown state in the method for fast resuming a computer system according to one embodiment of the present invention. As shown in FIG. 1 and FIG. 3, the computer system 100 receives a power control signal, such as a power suspended signal including the sleeping signal or suspended signal. According to the power suspended control signal, in the step S301, the operating system currently run by the central processing unit 102 executes the suspended state (i.e. the S3 state). In the step S305, the BIOS traps the suspended state so that the computer system 100 enters a system management mode (SMM). In the step S311, the BIOS stores a set of setting value of the chipset 110 of the computer system 100 into the system memory 104. In the step S315, the BIOS scans the system memory to build a system memory block address table of the system memory 104. It should be noticed that the BIOS builds the system memory block address table by using a memory block as a read-and-write unit and stores the system memory block address table in the system memory 104. In the step S321, the BIOS exits the system management mode. In the step S325, according to the system memory block address table, the BIOS sequentially stores the system memory data of the system memory 104 into the storage device 106. It should be noticed that, by using a memory block as a read-and-write unit and according to the system memory block address table, the BIOS sequentially stores the system memory data in each memory block into the storage device 106. For instance, the BIOS utilizes an optimized read-and-write block size as the read-and-write unit to read system memory data from the system memory 104 and write the read system memory data into the storage device 106.

In the step S331, the system memory block address table is stored into the storage device 106. In the step S335, the computer system enters the shutdown state (i.e. the S5 state), in which the BIOS sets the chipset 110 to be in the S5 state and cut off the power of the computer system 100.

In the present embodiment, when the user generates a power control signal through an input device or a power button in order to force the computer system 100 enters the suspended state, the system memory data in the system memory 104 is stored into the storage device 106 and then the computer system 100 enters the shutdown state and the power supplied onto the computer system is cut off. A hybrid suspending process of the present embodiment, in which the computer system enters the shutdown state from the temporal suspended state, combines the method for fast resuming the computer system illustrated in the previous embodiment so that the storage device 106 stores the system memory data of the system memory 104 before the computer system enters the shutdown state. Therefore, while the operating system is resume, the system memory data is restored into the system memory so that the system memory is back to a state as same as the state of the system memory before the computer system 100 enters the shutdown state. Thus, after the computer system 100 resumes the operating system, the operating state of the operating system is as same as the operating state of the operating system before the computer system 100 enters the shutdown state. The operating state of the operating system misleads the user to believe that the computer system 100 is resumed from the sleeping state or the suspended state and is not re-booted from the shutdown state. Moreover, in the present embodiment, since the operating system executes the suspended state (the S3 state) in response to the power suspended signal generated by the user and then the computer system enters the shutdown state in which the power required by the computer system is downed to the lower limit, the lifetime of the battery can be prevented from being shortened due to the continuously supplying power to the system memory as the computer system is at the suspended state. Moreover, the computer system 100 is resumed to be in an operating state as same as the operating state before the computer system 100 enters the shutdown state (the S5 state) so that the user would think the computer system is resumed from the suspended state (the S3 state). Therefore, the user perception of the use of present invention includes the advantages such as long suspended time and, meanwhile, high power saving and long battery lifetime.

FIG. 3A is a flow chart showing a procedure of a computer system entering the suspended state and being awoke from the suspended state before the computer system enters a shutdown state in the method for fast resuming a computer system according to one embodiment of the present invention. As shown in FIG. 3A, in one embodiment, before the step S321 of exiting the system management mode, the method of the present invention further comprises a step of setting a real-time clock (RTC) for determining a temporal suspended time interval for resetting the central processing unit 102. In addition, the step S321 of exiting the system management mode further comprises a step of computer system 100 entering the suspended state (the S3 state) so that the power supplying to the central processing unit 102 of the computer system 100 is cut off (step S351). After the temporal suspended time interval, the power is supplied to the central processing unit 102 and the central processing unit 102 is reset (step S355). The step of power supplying the central processing unit 102 comprises the step of an embedded controller (EC) or a hardware circuit power supplying the central processing unit 102 after the temporal suspended time interval.

That is, the temporal suspended time interval can be prolonged by setting the real-time clock. On the other words, in the step S321 of exiting the system management mode, the time interval between the power cut on the central processing unit 102 (step S351) and the re-power supply on the central processing unit 102 (step S355) can be extended so as to prolong the time in which the computer system 100 is in the suspended state (i.e. the S3 state). Moreover, the temporal suspended time interval can be customized by the user to determine the time in which the computer system 100 is in the suspended state while the hybrid suspending process is performed.

The aforementioned embodiment, in which the computer system 100 receives the power control signal which is the power suspended signal and the computer system performs the combination process of the hybrid suspending process and the method for fast resuming the computer system, is taken as an exemplar for illustrating an application of the resume method of the present invention which is capable of extending the suspended time and increasing the lifetime of the battery. However, the present invention is not limited by the aforementioned application. That is, the combination process of the hybrid suspending process of the present embodiment and the method for fast resuming the computer system can be applied for fast booting the computer system according to the received power control signal (such as the shutdown signal). An embodiment is described hereafter in order to explain the aforementioned application of fast booting the computer system.

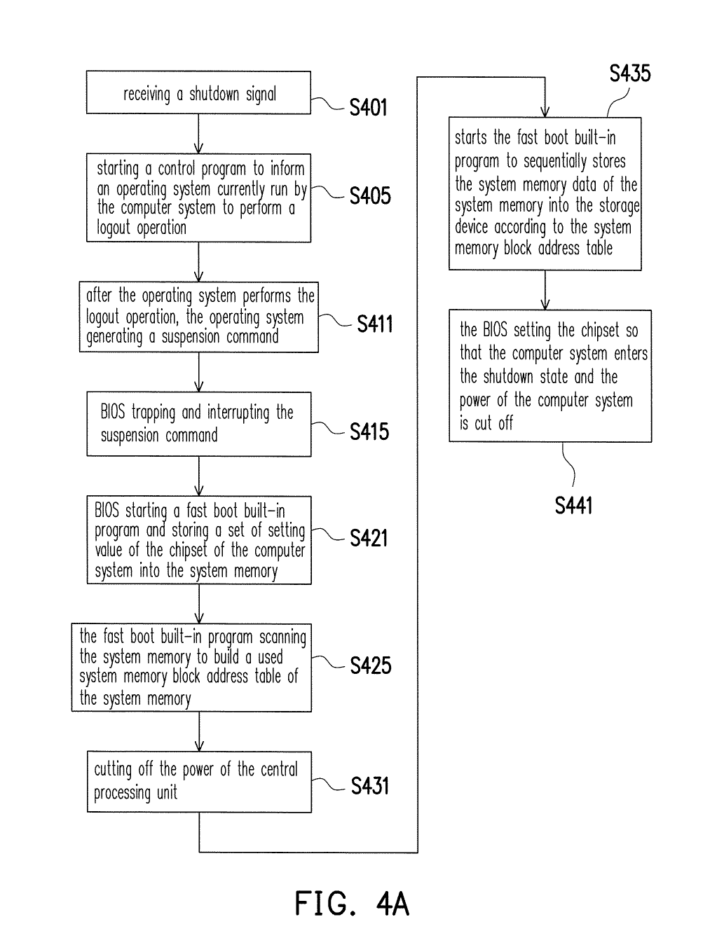

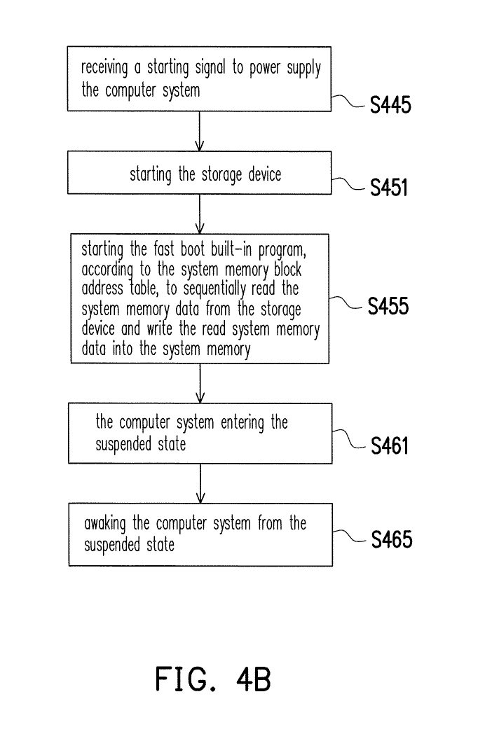

FIG. 4A is a flow chart showing a procedure of a computer system entering the shutdown state according to the power button, the hot key or the shutdown software in the method for fast resuming a computer system according to one embodiment of the present invention. As shown in FIG. 4, in the step S401, the central processing unit 102 of the computer system 100 receives a power control signal such as a shutdown signal. The shutdown signal can be generated from, for example, a power button, a hot key or a shutdown software. In the step S405, the central processing unit 102 starts a control program to inform an operating system currently run by the computer system to perform a logout operation. In the step S411, after the operating system performs the logout operation, the operating system generates a suspension command. Thereafter, the hybrid suspending process mentioned above is performed and the hybrid suspending process comprises the steps of BIOS trapping and interrupting the suspension command to enter the system management mode (step S415); BIOS starting a fast boot built-in program and storing a set of setting value of the chipset of the computer system into the system memory (step S421); the fast boot built-in program scanning the system memory to build a used system memory block address table of the system memory (step S425).

In the step S431, the power of the central processing unit 102 is cut off and the computer system 100 exits the system management mode. In the step S435, according to the system memory block address table, the BIOS starts the fast boot built-in program to sequentially stores the system memory data of the system memory 104 into the storage device 106 with the use of the optimized read-and-write block size as the read-and-write unit. In the step S441, the BIOS sets the chipset 110 so that the computer system 100 enters the shutdown state (i.e. the S5 state) and the power of the computer system 100 is cut off.

In one embodiment, before the power of the central processing unit 102 is cut off, the method of the present invention further comprises a step of setting a real-time clock for determining a temporal suspended time interval. Furthermore, the step of cutting off the power of the central processing unit 102 and the computer system 100 exiting the system management mode (step S431) further comprises the step of the computer system 100 enters the suspended state (the S3 state) so as to cut off the power of the central processing unit 102 (as the step S351 shown in FIG. 3A). The computer system 100 maintains in the suspended state for the temporal suspended time interval. After the temporal suspended time interval, the power is supplied onto the central processing unit 102 and the central processing unit 102 is reset (as the step S355 shown in FIG. 3A). It should be noticed that after the temporal suspended time interval, the step of power supplying the central processing unit 102 comprises the step of an embedded controller (EC) or a hardware circuit power supplying the central processing unit 102.

FIG. 4B is a flow chart showing a method for fast resuming a computer system after the computer system is shutdown by performing a hybrid suspending process according to one embodiment of the present invention. As shown in FIG. 4B, when the user starts the computer system 100 through the power button of the computer system 100, the computer system 100 receives a starting signal to power supply the computer system (step S445). In the step S451, the storage device 106 is started and in the step S455, the BIOS starts the fast boot built-in program, according to the system memory block address table, to sequentially read the system memory data from the storage device 106 and write the read system memory data into the system memory 104 with the use of the optimized read-and-write block size as the read-and-write unit. In the step S461, the BIOS enables the computer system to enter the suspended state (i.e. the S3 state) and in the step S465, the computer system is awoke from the suspended state.

In one embodiment, the step S455 of the fast boot built-in program sequentially reading the system memory data from the storage device 106 further comprises the fast boot built-in program automatically detecting an optimized read-and-write block size of the storage device 106 and using the optimized read-and-write block size as the read-and-write unit for the fast boot built-in program sequentially writing the read system memory data into the system memory 104. In another embodiment, the step S455 of the fast boot built-in program sequentially reading the system memory data from the storage device 106 further comprises the fast boot built-in program automatically reading a set value of a read-and-write block size of the storage device 106 and using the read set value as the optimized read-and-write block size. Moreover, the aforementioned set value of read-and-write block size of the storage device 106 can be a set value of an original data read-and-write block size of the storage device 106 or a read-and-write block size which is used to write the system memory data into the storage device 106 before the computer system shutdown. In the other embodiment, the optimized read-and-write block size is determined according to the size of the data to be accessed. That is, the optimized read-and-write block size is determined in order to achieve the goals including least data reading times and largest data accessing rate. In the other embodiment, the optimized read-and-write block size determined according to the storage capacity of the storage device. On the other words, the optimized read-and-write block size is determined in order to achieve the goals including least data reading times and largest data accessing rate.

Further, in one embodiment, after the power is supplied onto the computer system 100, the method of the present invention further comprises the fast boot built-in program clearing the system memory 104 (as the step S255 shown in FIG. 2A). In addition, before the fast boot built-in program clears the system memory 104, the method of the present invention further comprises the step of initializing the system memory 104 (as the step S251 shown in FIG. 2A) and after the fast boot built-in program clears the system memory 104, the method of the present invention further comprises the step of initializing the storage device 106 (as the step S261 shown in FIG. 2A).

It should be noticed that, in the method for fast resuming the computer system from the shutdown state of the present embodiment, during the last shutdown process, after the operating system completes the logout operation, the operating system enters the S3 state so that the system memory data in the system memory 104 can be sequentially stored into the storage device 106 according to the system memory block address table and then the computer system 100 enters the S5 state. Thereafter, when the computer system 100 receives the starting signal (booting signal), the BIOS sequentially restores the system memory data stored in the storage device 106 before the computer system enters the shutdown state into the system memory 104 according to the system memory block address table and the operating system is awoke from the S3 state. It should be noticed that the operating state of the awoke operating system is as same as the operating state of the operating system before the computer system enters the shutdown state (that is, the operating state of the awoke operating system is as same as the operating state of the operating system while the operating system completes the logout operation). Therefore, according to the present invention, the booting procedure of the computer system 100 omits the redundant steps of the BIOS scanning the peripheral hardware device of the computer system and writing related setting values to the peripheral hardware devices in the conventional booting procedure from the S5 state and saves the time for initiating the system background programs (such as anti-virus programs or internet signal auto-detecting program) as the booting procedure is completed and the operating system starts. Thus, the goal for fast booting (resuming) the computer system can be achieved.

Altogether, in the present invention, the computer system runs the operating system to executes the S3 state, the system memory data of the system memory is sequentially stored into the storage device and then the computer system enters the S5 state. Therefore, after the computer receives the resuming signal, the BIOS sequentially restores the system memory data stored in the storage device into the system memory and the operating system is awoke from the S3 state. That is, the operating state of the awoke operating system is as same as the operating state of the operating system before the computer system enters the shutdown state. Hence, the combination of the hybrid suspending process and the method for fast resuming the computer system omits the redundant steps of scanning the peripheral hardware device of the computer system and writing related setting values to the peripheral hardware devices in the booting procedure from the S5 state and further omits the steps of initiating the system background programs as the booting procedure is completed and the operating system starts. Thus, it is not necessary for the user to spend a lot of time to wait the computer system goes through the redundant booting steps and the environment preparation steps of the operating system. Therefore, the goal for fast resuming or booting the computer system can be achieved. Furthermore, in response to the power suspended signal generated by the user, the operating system enters the S3 state and then enters the S5 state so that the power required by the computer system is downed to the lower limit so that the lifetime of the battery can be prevented from being shortened due to the continuously supplying power to the system memory as the computer system is at the suspended state. Additionally, when the computer system is resumed to be in the operating state as same as the operating state of the operating system before the computer system enters the S5 state, so that the user would think the computer system is resumed from the S3 state. Thus, the user perception of the use of present invention includes the advantages such as long suspended time. Moreover, since the read-and-write unit changes with the size of the data to be accessed, the storage capacity of the storage device or the set value of read-and-write block size of the storage device, the operation for reading and writing the system memory data possesses faster operating speed in comparison with the conventional block-by-block data read-and-write operation with the use of the fixed block size as the read-and-write unit. On the other words, the whole speed for awaking the computer system is increased.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for fast resuming a computer system from a shutdown state, wherein the computer system comprises a basic input output system, a system memory and a storage device, and the storage device stores a system memory data of the system memory and a used system memory block address table before the computer system enters the shutdown state, the method comprising:
receiving a starting signal for power supplying the computer system;
starting the storage device;
starting a fast boot built-in program of the basic input output system, according to the used system memory block address table, to sequentially read the stored system memory data from the storage device and write the read system memory data into the system memory with a use of an optimized read-and-write block size as a read-and-write unit;
the computer system entering a suspended state; and
resuming the computer system from the suspended state.

2. The method of claim 1, wherein the computer system comprises a central processing unit and a chipset, and the computer system entering the shutdown state further comprises:
cutting off the power supplying to the central processing unit;
starting the fast boot built-in program, according to the used system memory block address table, to sequentially store the system memory data of the system memory into the storage device with the use of the optimized read-and-write block size as the read-and-write unit; and
the basic input output system setting the chipset to enable the computer system to enter the shutdown state.

3. The method of claim 2, before the step of cutting off the power supplying to the central processing unit, further comprising:
receiving a shutdown signal; and
according to the shutdown signal, starting a control program to inform an operating system currently run by the computer system to perform a logout operation.

4. The method of claim 3, before the step of cutting off the power supplying to the central processing unit and after the step of performing the logout operation, further comprising:
the operating system currently run by the computer system generating a suspension command;
the basic input output system trapping and interrupting the suspension command;
the basic input output system starting the fast boot built-in program to store a set of setting value of the chipset into the system memory; and
the fast boot built-in program scanning the system memory to build the used system memory block address table of the system memory.

5. The method of claim 2, before the step of cutting off the power supplying to the central processing unit, further comprising setting a real-time clock for determining a temporal suspended time interval, wherein the step of cutting off the power supplying to the central processing unit further comprises:
the computer system entering the suspended state so as to cut off the power of the central processing unit; and
after the computer system maintains in the suspended state for the temporal suspended time interval, power supplying the central processing unit and resetting the central processing unit.

6. The method of claim 5, wherein the step of power supplying the central processing unit after the temporal suspended time interval comprises the step of an embedded controller (EC) or a hardware circuit power supplying the central processing unit.

7. The method of claim 1, wherein before the computer system enters the shutdown state, an operating system run by the computer system is at a first operating state and when the computer system is resumed from the suspended state, the operating system run by the computer system is at a second operating state as same as the first operating state.

8. The method of claim 1, after the step of power supplying the computer system, further comprising the fast boot built-in program clearing the system memory.

9. The method of claim 8, before the step of the fast boot built-in program clearing the system memory, further comprising initializing the system memory and after the step of the fast boot built-in program clearing the system memory, further comprising initializing the storage device.

10. The method of claim 1, wherein the step of fast boot built-in program, according to the used system memory block address table, sequentially reading the stored system memory data from the storage device further comprises the fast boot built-in program automatically detecting the optimized read-and-write block size of the storage device.

11. The method of claim 1, wherein the step of fast boot built-in program, according to the used system memory block address table, sequentially reading the stored system memory data from the storage device further comprises the fast boot built-in program automatically reading a set value of a read-and-write block size of the storage device and using the read set value as the optimized read-and-write block size.

12. The method of claim 11, wherein the set value of read-and-write block size of the storage device is a set value of an original data read-and-write block size of the storage device or a read-and-write block size which is used to write the system memory data into the storage device before the computer system shutdown.

13. A computer system, comprising:
a central processing unit executing an operating system;
a chipset;
a system memory;
a storage device, wherein when the computer system is in a shutdown state, the storage device stores a system memory data of the system memory and a used system memory block address table before the computer system enters the shutdown state;
a basic input output system, wherein when the computer system is in a shutdown state and is resumed from the shutdown state, the basic input output system:
starting a fast boot built-in program of the basic input output system, according to the used system memory block address table, to sequentially read the stored system memory data from the storage device and write the read system memory data into the system memory with a use of an optimized read-and-write block size as a read-and-write unit;
making the computer system to enter a suspended state; and
resuming the computer system from the suspended state.

14. The computer system of claim 13, wherein when the computer system in the shutdown state and a power of the central processing unit is cut off, the basic input and output system:
starting the fast boot built-in program, according to the used system memory block address table, to sequentially store the system memory data of the system memory into the storage device with the use of the optimized read-and-write block size as the read-and-write unit; and
setting the chipset to enable the computer system to enter the shutdown state.

15. The computer system of claim 14, wherein before the power of the central processing unit is cut off, the operating system generates a suspension command and the basic input and output system:
trapping and interrupting the suspension command; and
starting the fast boot built-in program to store a set of setting value of the chipset into the system memory and scanning the system memory to build the used system memory block address table of the system memory.

16. The computer system of claim 15, further comprising a real-time clock, wherein the basic input output system sets the real-time clock for determining a temporal suspended time interval, enables the computer system maintaining in the suspended state for the temporal suspended time interval in which the power of the central processing unit is cut off and power supplies and rests the central processing unit after the temporal suspended time interval.

17. The computer system of claim 16, further comprising a controller for power supplying and resetting the central processing unit.

18. The computer system of claim 14, wherein before the power of the central processing unit is cut off, the central processing unit:
receiving a shutdown signal; and
according to the shutdown signal, starting a control program to inform the operating system currently run by the computer system to perform a logout operation.

19. The computer system of claim 13, wherein before the computer system is in the shutdown state, the operating system run by the computer system is at a first operating state and when the computer system is resumed from the suspended state, the operating system run by the computer system is at a second operating state as same as the first operating state.

20. The computer system of claim 13, wherein when the computer system is resumed from the shutdown state, before the used system memory block address table is read from the storage device, the basic input output system:
initializing the system memory;
clearing a memory content of the system memory; and
initializing the storage device.
